(19) United States
(12) Patent Application Publication
(10) Pub. No.: US 2008/0290047 A1
(43) Pub. Date: Nov. 27, 2008

(54) Method and apparatus for filtering flowable material

(76) Inventors: Randolph W. Zahn, Evansville, IN (US); Michelle M. Hibdon, Haubstadt, IN (US); H. Thomas Miller, Evansville, IN (US)

Correspondence Address: Gary K. Price, Esq.;Bowers Harrison, LLP, 25 N.W. Riverside Drive, P.O. Box 1287, Evansville, IN, 47706-1287, US

(21) Appl. No.: 12/151,479

(22) Filed: May 7, 2008

Related U.S. Application Data
(60) Provisional application No. 60/931,233, filed on May 22, 2007.

(51) Int. Cl. B01D 35/143; B01D 37/00; B01D 25/12

(52) U.S. Cl. 210/767; 210/106; 210/231; 210/230

(57) ABSTRACT

A method and filter element for filtering flowable material. The filter element includes a top plate, a bottom plate, and a middle plate sandwiched therebetween. The top plate includes a first outlet to receive unfiltered material. The middle plate is interposed between the top plate and bottom plate and supports a meshed surface in order to strain oversized particles therefrom. The filter element is designed such that the axial length between the first outlet of the top plate and the middle plate is less than the axial length between the middle plate and the second outlet. The filter member of the middle plate is disposed in a direction perpendicular to the flow of material passing through the first outlet such that the approximate entire surface of the middle plate is used in the filtering process.

### CROSS REFERENCES TO RELATED APPLICATIONS

U.S. Provisional Application for patent No. 60/931,233, filed May 22, 2007, with title “Method and Apparatus for Filtering Flowable Material” which is hereby incorporated by reference. Applicant claims priority pursuant to 35 U.S.C. par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates generally to filters, and more particularly to a new method and apparatus for separating unwanted particulate material from a stream of flowable material.

2. Brief Description of Prior Art

It is a continuing problem in the processing of flowable material to ensure that the material fed through the machine for processing is free of unwanted material, such as particles of dirt, metal, lumps of gel and carbonized material produced for example in the mixing, blending and pressurizing stages of the machine. The presence of particles in the material can cause damage to the machine and resulting product. Filtering out apparatuses are already known. The filtering apparatus serves the purpose of isolating dirt and contaminating substances contained in the raw material, from the finished product. As is further known in the art, filtering apparatuses generally have to be exchanged and cleaned from time to time. In this regard, as the filter retains more and more of the filtered unwanted particles its flow capacity is reduced until eventually it must be changed or cleaned. Such filter changes usually require cessation of the machine's operation. It should be understood that frequent disruptions for replacing filters is economically unacceptable. Further, with prior art designs, it is common to lose unacceptable amounts of raw material during the filter replacing process. Various arrangements have been proposed, such as rotating or alternating quick-change filters, in an effort to minimize the time during which the machine is out of action. However, the inventor has found all such arrangements unsuitable.

As can be seen, there is a need for an improved filtering system for separating unwanted particulate material from a stream of flowable material. The present method and apparatus satisfies this need.

### SUMMARY OF THE INVENTION

The present invention is directed to a method and filter element for filtering flowable material. The filter element includes a top plate, a bottom plate, and a middle plate sandwiched therebetween. The top plate includes a first outlet to receive unfiltered material. The middle plate is interposed between the top plate and bottom plate and includes a meshed surface, filter element in order to strain oversized particles therefrom. In particular, the middle plate functions as a support for a wire mesh screen to first filter out particles. The middle plate includes a plurality of openings that allows material to pass through after passing through the wire mesh screen. The filter element is designed such that the axial length between the first outlet of the top plate and the middle plate is less than the axial length between the middle plate and the second outlet. The filter member of the middle plate comprises a circular layer of wire filter of mesh disposed in a direction perpendicular to the flow of material passing through the first outlet such that the approximate entire surface of the middle plate is used in the filtering process.

In operation, a stream of liquid material under high pressure enters the filter element through the first outlet and flows axially through the mesh surface of the middle plate to the area below the filter element and through the second outlet. Any material such as contaminant particles that are unable to pass through the mesh remains substantially on the top area of the mesh surface and is prevented from passing through to the second outlet. As a result, a slow but steady buildup of deposited material is experienced adhering to the wire mesh screen disposed above the middle plate. To replace the filter member, the user can simply remove the top plate to access the middle plate with very little loss of material.

### BRIEF DESCRIPTION OF THE DRAWINGS

FIG. 1 is a top view of the present invention, an apparatus for filtering flowable material.

FIG. 2 is a side view of the apparatus of FIG. 1.

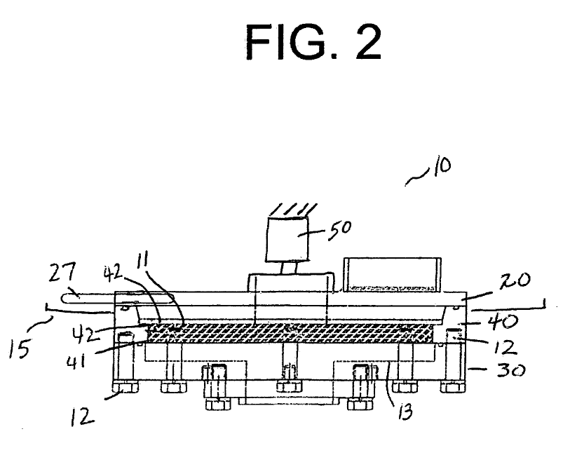

FIG. 3 is a top view of the apparatus' bottom plate.

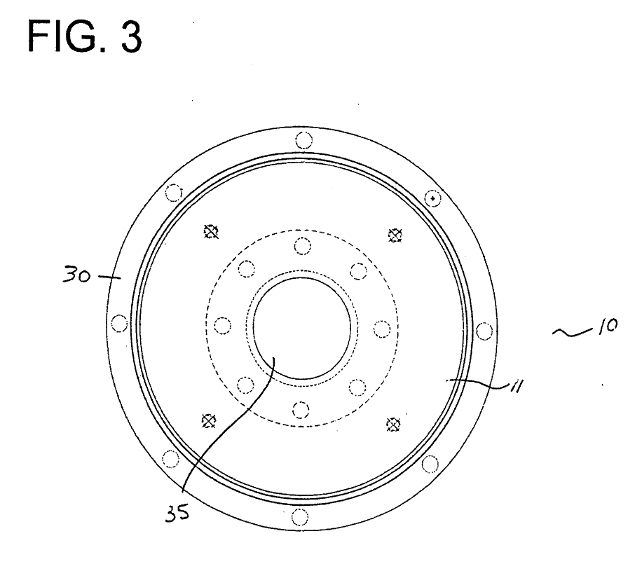

### DESCRIPTION OF THE PREFERRED EMBODIMENT

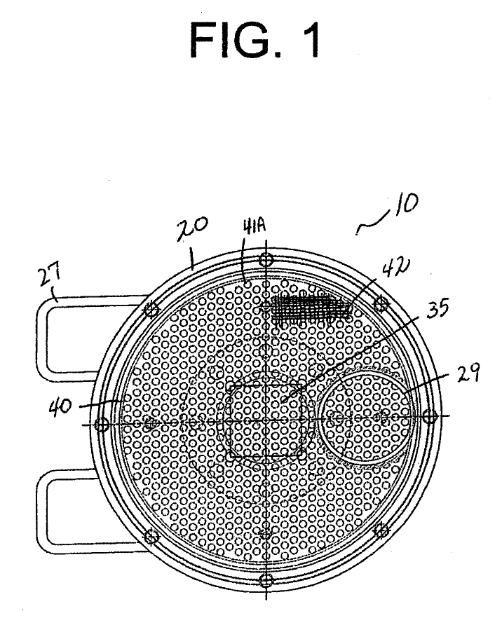

In accordance with the present invention, a method and apparatus for filtering flowable material is disclosed. FIG. 1 shows a top view of a filter element 10 that forms part of the machine (not shown) for processing. The filter element 10 includes top and bottom plates 20, 30 respectively, and a middle plate 40 sandwiched therebetween. The top plate 20 includes a first machine outlet 29 (inlet to filter 10) to receive unfiltered material. As is known, the unfiltered material with unfiltered particulate material mixed therein is discharged continuously from a machine outlet, and through the first outlet 29. It is further known that large particles, for example dirt or overheated gelled or carbonized material, should not be permitted to pass through the filter element 10. The middle plate 40 in accordance with this invention is interposed between the top plate 20 and bottom plate 30 and includes a surface 41 having a plurality of openings 41A that support a filter media such as a wire mesh screen 42 (a partial section of which is shown in FIG. 1) in order to strain oversized particles therefrom.

The filter element 10 which constitutes this particular embodiment, includes the top and bottom plates 20, 30 being pinned in precise alignment with one another by circumferentially disposed and fastened rigidly together by heavy screws such as 12. The plates 20, 30 generally are symmetrical about a longitudinal axis 15, and have respectively the first outlet 29 and a central second outlet 35 disposed in the bottom plate 30. In this embodiment the outlets 29, 35 not being co-axial with another. The middle plate 40 is mounted within a chamber 11 that defines an accumulation area for unfiltered material. The chamber 11 is sandwiched between the plates 20, 30. The chamber 11 representing the interior of the filter element 10. The top plate 20 further includes at least one extended handle 27.

The first element 10 is so designed that the axial length between the first outlet 29 of the top plate 20 and the middle plate 40 is less than the axial length between the middle plate 40 and the second outlet 35. As a result, there is less area on top of the middle plate 40, that area being between the middle plate 40 and the first outlet 29. This reduces the amount of material that might be wasted in filter cleanings by keeping the volume on top of the filter media wire screen 42 small but also allows fluid to run from the area 11 above the filter media, through the media and into the larger volume area 13 below. Such that after the machine is shut off and the filter 10 is being serviced minimum waste occurs.

In the preferred embodiment, the wire mesh screen 42 is supported by the middle plate 40 and comprises a circular layer of wire filter mesh disposed in a direction perpendicular to the flow of material passing through the first outlet 29, so that the approximate entire surface of the middle plate 40 is used in the filtering process. In this regard, the middle plate 40 and therefore wire mesh screen 42 is in precise alignment with the plates 20, 30 and are likewise symmetrical about the longitudinal axis 15.

In operation, a stream of liquid material under high pressure enters the filter element's 10 chamber 11 through the first outlet 29 and then flows axially through the wire mesh screen 42, and then through the middle plate 40, through holes 41A to the area 13 defined below the middle plate 40 within the chamber 11, and through the second outlet 35. Any material such as contaminant particles that are unable to pass through the wire mesh screen 42 remains substantially on the top area of the screen 42 and is prevented from passing through the second outlet 35 as described above. As a result, a slow but steady buildup of deposited material is experienced above the middle plate 40. This steady buildup accumulates until an operative maximum buildup is reached which triggers a pressure signal indicating a need to service the filter 10. At that time, the wire mesh screen 42 above the middle plate 40 can be replaced by removing the top plate 20 with very little loss of material. The top plate 20 is normally held in place by cylinder 50 which can be a hydraulic or pneumatic cylinder that holds the top plate in place on the filter 10. During servicing, the top plate 20 is lifted by cylinder 50 and handles 27 can be used by an operator to guide the top plate 20 in upward and downward movement.

It is found that for effective and economic operation of the device, the quantity of material loss when changing the wire mesh filter 42 above the middle plate 40 should be as small as possible. It is also found preferable as a general rule to arrange that the flow through the device is as smooth and as streamlined as possible in order to prevent hang-up and degradation of the processed material. It will be understood that the filter screen 42 has smaller openings than the openings 41A and that any size of openings in the screen could be chosen from a few hundredths of an inch down to a few microns. The smaller the openings in the filter media screen 42, the larger will be the normal back pressure in cavity 11 during operation.

As should be understood, the wire mesh filter 42 supported by the middle plate 40 filters out any large oversized particles, and prevents passage thereof to and through the middle plate 40. The material having the particles strained therefrom then flows through the middle plate 40 and holes 41A and then through the second outlet 35.

Although the description above contains many specificities, these should not be construed as limiting the scope of the invention but as merely providing illustrations of some of the presently preferred embodiments of this invention. As such, it is understood that the present invention is not limited to the embodiments described above, but encompasses any and all embodiments within the scope of the claims.

It will be obvious to those skilled in the art that modifications may be made to the embodiments described above without departing from the scope of the invention. Thus the scope of the invention should be determined by the claims in the formal application and their legal equivalents, rather than by the examples given.

I claim:

1. A filter element for filtering flowable material, said filter element comprising:
a top plate, a bottom plate, and a middle plate disposed in a chamber defined by said top and bottom plates, wherein said middle plate sandwiched between said top and bottom plates,
said top plate including a first outlet to receive unfiltered material,
said middle plate supporting a meshed surface in order to strain oversized particles from the flowable material,
wherein the axial length between the first outlet of the top plate and the middle plate is less than the axial length between the middle plate and the second outlet,
wherein said meshed surface of the middle plate is disposed in a direction perpendicular to the flow of material passing through the first outlet such that the approximate entire surface of the meshed surface is used in the filtering process.

2. The filter element as recited in claim 1, including pins to locate the top plate on the middle plate and a powered cylinder to lift the top plate for changing said meshed surface and said cylinder maintaining pressure on said top plate during fluid filtering.

3. The filter element as recited in claim 2, including a sensor to detect a pressure rise to indicate the need to service said filter.

4. The filter element as recited in claim 2, wherein said meshed surface is a removable wire mesh resting on a upper surface of said middle plate and wherein said middle plate includes a plurality of first openings spaced across most of said upper surface.

5. The filter element as recited in claim 4, wherein said mesh surface has a plurality of second openings, wherein said second openings are substantially smaller than said first openings.

6. The filter element as recited in claim 4, wherein said top plate includes a handle to allow an operator to guide the motion of said top plate when it is being moved by said cylinder.

7. The filter element as recited in claim 4, wherein said middle plate divides said chamber into an upper portion and a lower portion and wherein said lower portion has a larger volume than said upper portion.

8. A filter for filtering flowable material, said filter comprising:
a top plate, a bottom plate, and a middle plate disposed in a chamber defined by said top and bottom plates, wherein said middle plate sandwiched between said top and bottom plates,
said top plate including a first outlet to receive unfiltered material,
said middle plate including a removable meshed surface in order to strain the flowable material,
wherein a first portion of a volume of said chamber between the first outlet of the top plate and the middle plate is less than a second volume of said chamber between the middle plate and the second outlet,
wherein said meshed surface on the middle plate is disposed in a direction perpendicular to the flow of material passing through the first outlet such that the approximate entire surface of the meshed surface is used in the filtering process.

9. The filter element as recited in claim 8, including a powered cylinder to lift the top plate for exposing said meshed surface and said cylinder maintaining pressure on said top plate during fluid filtering.

10. The filter element as recited in claim 8, wherein said meshed surface is a removable wire mesh resting on an upper surface of said middle plate and wherein said middle plate includes a plurality of first openings spaced across most of said upper surface.

11. The filter element as recited in claim 10, wherein said meshed surface has a plurality of second openings, wherein said second openings are substantially smaller than said first openings.

12. The filter element as recited in claim 10, wherein said top plate includes handles to allow an operator to guide the motion of said top plate when it is being moved by said cylinder.

13. A method for filtering flowable material comprising the steps of:
receiving a stream of liquid material under high pressure, wherein said material enters a filter's element through a first outlet, wherein said material flows axially through a filter member supported by a middle plate to an area below said filter element and through a second outlet, wherein any material such as contaminant particles that are unable to pass through said filter member remains substantially on a top area of said filter member and is prevented from passing through to said second outlet, wherein a first portion of a volume of said chamber between the first outlet and the middle plate is less than a second volume of said chamber between the middle plate and the second outlet.
